(19) United States
(12) Patent Application Publication
(10) Pub. No.: US 2025/0315376 A1
(43) Pub. Date: Oct. 9, 2025

(54) CONCURRENT ADDRESS TRANSLATION SCHEMES FOR MEMORY SUB-SYSTEMS IN A DISAGGREGATED MEMORY ENVIRONMENT

(71) Applicant: Micron Technology, Inc., Boise, ID (US)

(72) Inventors: Patrick Estep, Rowlett, TX (US); Bryan Dale Hornung, Plano, TX (US); Craig William Warner, Coppell, TX (US)

(21) Appl. No.: 19/097,029

(22) Filed: Apr. 1, 2025

Related U.S. Application Data
(60) Provisional application No. 63/574,844, filed on Apr. 4, 2024.

(51) Int. Cl. G06F 12/02

(52) U.S. Cl. CPC G06F 12/0246; G06F 2212/7201

(57) ABSTRACT

A processing device in a system receives a first request for a first set of memory addresses. The processing device determines, based on the first request, whether to assign a first set of physical addresses of a portion of physical addresses of a memory device as the first set of memory addresses. Responsive to determining not to assign the first set of physical addresses, the processing device requests a first set of virtual addresses of a plurality of contiguous virtual addresses. A first portion of virtual addresses of the plurality of contiguous virtual addresses contiguously maps to a second portion of physical addresses of the memory device. The processing device stores data to a second set of physical addresses contiguously mapped to the first set of virtual addresses.

### CLAIM OF PRIORITY

The present application claims the benefit under 35 U.S.C. § 119(e) of U.S. Provisional Patent Application No. 63/574,844 filed Apr. 4, 2024, which is incorporated by reference herein.

### TECHNICAL FIELD

Embodiments of the disclosure relate generally to memory sub-systems, and more specifically, relate to using concurrent address translation schemes for memory sub-systems in a disaggregated memory environment.

### BACKGROUND

A memory sub-system can include one or more memory devices that store data. The memory devices can be, for example, non-volatile memory devices and volatile memory devices. In general, a host system can utilize a memory sub-system to store data at the memory devices and to retrieve data from the memory devices.

### BRIEF DESCRIPTION OF THE DRAWINGS

The present disclosure will be understood more fully from the detailed description given below and from the accompanying drawings of various embodiments of the disclosure.

FIG. 1A illustrates an example computing environment that includes a memory sub-system in accordance with aspects of the disclosure.

FIG. 1B is a block diagram of a computing environment of a disaggregated memory environment, in accordance with aspects of the disclosure.

FIG. 1C is a block diagram of the computing environment of a disaggregated memory environment, in accordance with aspects of the disclosure.

FIG. 2A illustrates an example of a disaggregated memory environment that includes a virtual address manager, in accordance with aspects of the disclosure.

FIG. 2B is a flow diagram of an example of a method of a memory sub-system aware prefetching, in accordance with aspects of the disclosure.

FIG. 3 is a flow diagram of an example method of a concurrent address translation scheme in a disaggregated memory environment, in accordance with aspects of the disclosure.

FIG. 4 is a flow diagram of an example method of a concurrent address translation scheme in a disaggregated memory environment, in accordance with aspects of the disclosure.

FIG. 5 is a flow diagram of an example method of a a concurrent address translation scheme in a disaggregated memory environment, in accordance with aspects of the disclosure.

FIG. 6 is a block diagram of an example computer system in which embodiments of the present disclosure may operate.

### DETAILED DESCRIPTION

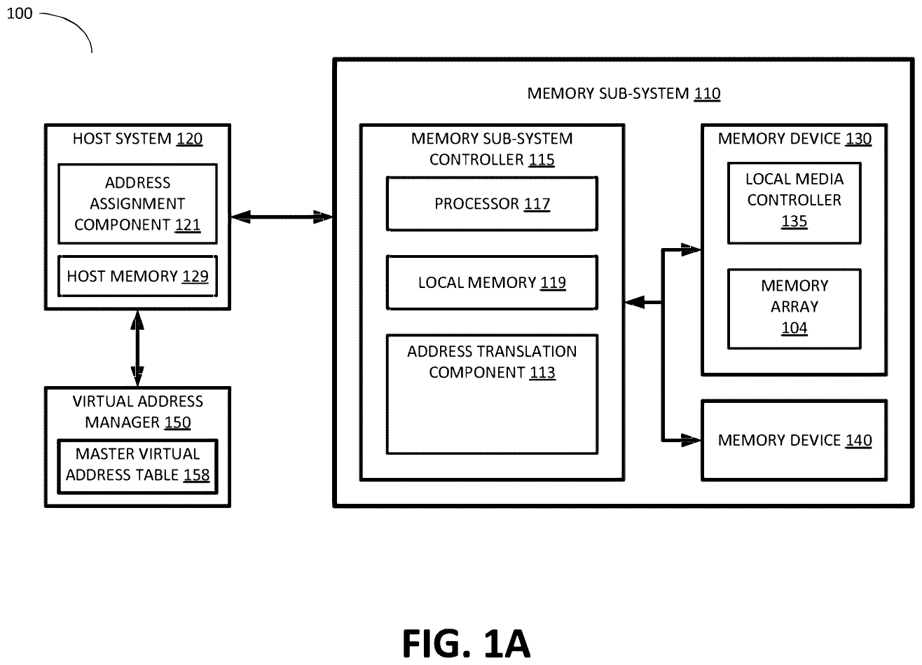

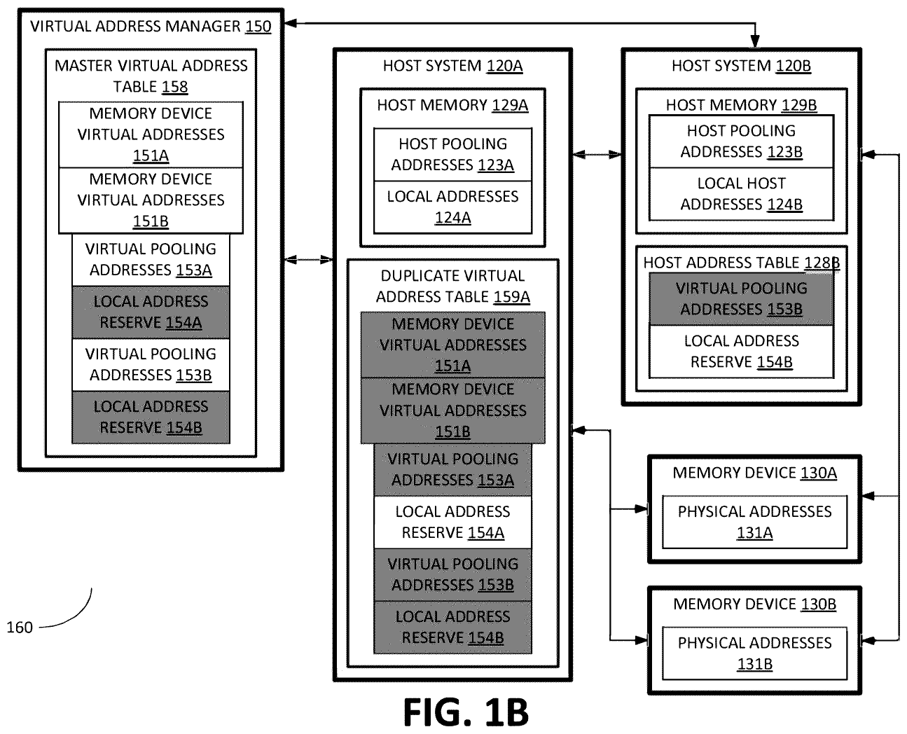

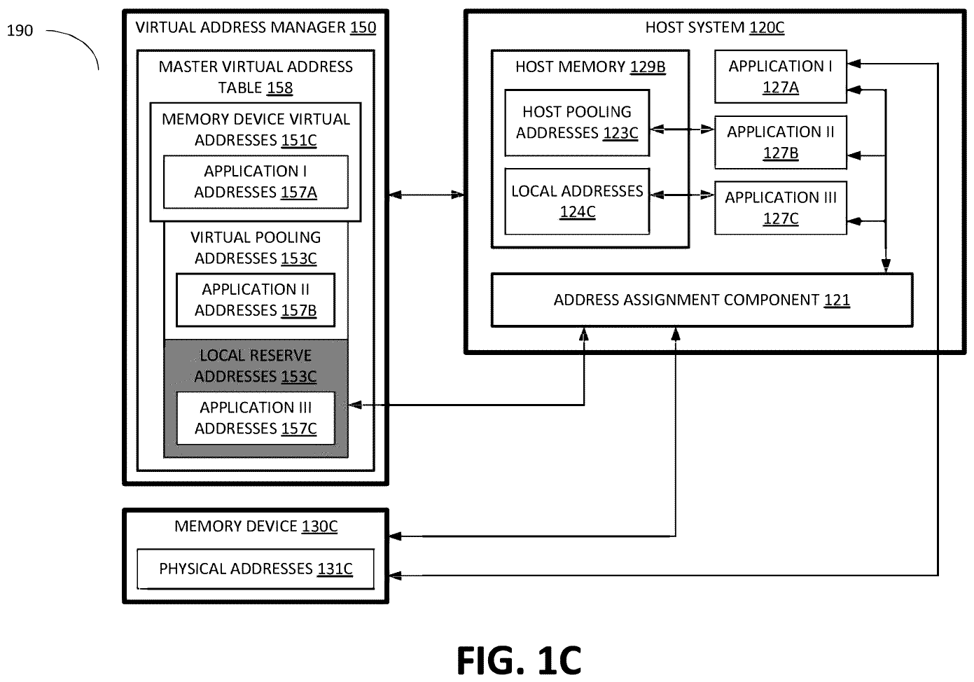

Aspects of the present disclosure are directed to using concurrent address translation schemes for memory sub-systems in a disaggregated memory environment. A memory sub-system can be a storage device, a memory sub-system, or a hybrid of a storage device and memory sub-system. Examples of storage devices and memory sub-systems are described below in conjunction with FIG. 1A. In general, a host system can utilize a memory sub-system that includes one or more components, such as memory devices that store data. The host system can provide data to be stored at the memory sub-system and can request data to be retrieved from the memory sub-system.

A memory sub-system can include memory devices used to temporarily store data while power is supplied to the memory device (e.g., volatile memory). A memory sub-system can include memory devices used to retain data when no power is supplied to the memory device. To store and access data of the memory device, the memory device can be sequentially indexed by physical addresses. To write data to the memory device, a write operation can include one or more physical addresses (or a starting physical address), and data to be stored at the one or more physical addresses. To read data from the memory device, a read operation can include one or more physical addresses (e.g., a range of physical addresses), and can return the data stored at the one or more physical addresses.

One example of a non-volatile memory device is a NAND memory device, or 3D flash NAND memory device, which can be made up of bits arranged in a two-dimensional or a three-dimensional grid. Memory cells are formed onto a silicon wafer in an array of columns (also hereinafter referred to as bitlines) and rows (also hereinafter referred to as wordlines). A wordline can refer to one or more rows of memory cells of a NAND memory device that are used with one or more bitlines to generate the address of each of the memory cells. The intersection of a bitline and wordline constitutes the address of the memory cell. Thus, logic states of individual memory cells in a non-volatile NAND memory device can be stored with a write command that includes the address of the memory cell (identified by the intersection of a bitline and wordline) and the logical state to be stored at the memory cell.

Memory sub-systems can be used in a datacenter with a “disaggregated memory” computer environment, such as a computer environment based on the compute express link (CXL) protocol (e.g., including CXL 2.0, CXL 3.0, CXL 3.1, etc.). In a disaggregated memory environment, memory resources can be decoupled from individual nodes (e.g., servers, hosts, compute units, etc.) within a computing environment. Memory resources can be combined into a shared addressable pool (e.g., disaggregated memory pool, or memory pool) composed of multiple memory sub-systems. The memory resources of the memory sub-systems (e.g., the physical addresses of the memory sub-systems) can be centrally accessible to multiple nodes. Disaggregated memory environments can optimize resource addresses by dynamically distributing memory to high-demand areas, and reduce unnecessary expensive data redundancy.

When a process or application requests memory addresses to store data, a disaggregated memory pool can assign from whatever memory resources (e.g., physical memory addresses) are currently available. The disaggregated memory pool can be logically viewed as a continuous resource. Therefore, data for a particular application can be stored in any order across any quantity of memory sub-systems of the disaggregated memory pool, based primarily on which physical addresses were available at the time that the application requested memory resources (e.g., an assignment of memory addresses). Because memory resources can be assigned based on availability at the time the addresses are requested, there might not be a pattern or connection between the physical addresses of multiple memory sub-systems that have been used to store data for a particular application of the host.

Typically, dedicated memory sub-systems (e.g., including memory devices or memory modules) have been used in disaggregated memory pools. Recent advancements (e.g., such as described in the CXL 3.1 specification) enable host memory resources to be added to a disaggregated memory pool. While adding host memory resources to the disaggregated memory pool can improve the overall performance of the nodes in a disaggregated memory environment, many embodiments provide only minimal configurations for host memory optimization.

Aspects of the present disclosure address the above and other deficiencies by using concurrent address translation schemes for memory sub-systems in a disaggregated memory environment. A host system can include an address assignment component that receives requests from applications of the host and determines whether the application can receive a local memory address assignment, or a virtual memory address assignment. Applications that receive local memory address assignments can use local address translation schemes to process data stored at the local memory address assignment (e.g., at the physical memory addresses). Applications that receive a virtual memory address assignment can use a global address translation scheme (e.g., virtual addresses assigned and mapped through a global allocator) to process data stored at a physical location that maps to respectively assigned virtual addresses. The global address translation scheme is enabled, in part due to a contiguous mapping of sets of contiguous physical addresses (e.g., physical addresses of multiple memory sub-systems) to a set of contiguous virtual addresses of a disaggregated memory pool. A virtual address manager (e.g., global allocator) can assign contiguous blocks of virtual addresses (mapped to corresponding contiguous blocks of physical addresses) to respective applications of a respective host.

Advantages of the approach described herein include, but are not limited to, improved performance of a disaggregated memory environment. Further, a uniform global address translation scheme can facilitate efficient use of memory resources, and simplify memory access requests. As a result, applications that are built to interface with the approach described herein can have substantially improved performance in a disaggregated memory environment over applications that do not interface with the approach described herein.

FIG. 1A illustrates an example computing system 100 that includes a memory sub-system 110 in accordance with aspects of the present disclosure. The computing system 100 can be a computing device such as a desktop computer, laptop computer, network server, mobile device, a vehicle (e.g., airplane, drone, train, automobile, or other conveyance), Internet of Things (IoT) enabled device, embedded computer (e.g., one included in a vehicle, industrial equipment, or a networked commercial device), or such computing device that includes memory and a processing device. The computing system 100 can include a host system 120 that can be coupled to one or more memory sub-systems 110. In some embodiments, the host system 120 can be coupled to different types of memory sub-system 110. FIG. 1A illustrates one example of a host system 120 coupled to one memory sub-system 110. As used herein, “coupled to” or “coupled with” generally refers to a connection between components, which can be an indirect communicative connection or direct communicative connection (e.g., without intervening components), whether wired or wireless, including connections such as electrical, optical, magnetic, etc.

A memory sub-system 110 can be a storage device, a memory module, or a hybrid of a storage device and memory module. Examples of a storage device include a solid-state drive (SSD), a flash drive, a universal serial bus (USB) flash drive, an embedded Multi-Media Controller (eMMC) drive, a Universal Flash Storage (UFS) drive, a secure digital (SD) card, and a hard disk drive (HDD). Examples of memory modules include a dual in-line memory sub-system (DIMM), a small outline DIMM (SO-DIMM), and various types of non-volatile dual in-line memory modules (NVDIMMs).

The host system 120 can include a processor chipset and a software stack executed by the processor chipset. The processor chipset can include one or more cores, one or more caches, a memory controller (e.g., NVDIMM controller), and a storage protocol controller (e.g., PCIe controller, SATA controller). The host system 120 uses the memory sub-system 110, for example, to write data to the memory sub-system 110 and read data from the memory sub-system 110.

The host system 120 can be coupled to the memory sub-system 110 via a physical host interface. Examples of a physical host interface include, but are not limited to, a serial advanced technology attachment (SATA) interface, a peripheral component interconnect express (PCIe) interface, universal serial bus (USB) interface, Fibre Channel, Serial Attached SCSI (SAS), a double data rate (DDR) memory bus, Small Computer System Interface (SCSI), a dual in-line memory sub-system (DIMM) interface (e.g., DIMM socket interface that supports Double Data Rate (DDR)), etc. The physical host interface can be used to transmit data between the host system 120 and the memory sub-system 110. In some embodiments, the physical host interface can include the virtual address manager 150. The host system 120 can further utilize an NVM Express (NVMe) interface to access the memory components (e.g., the one or more memory device(s) 130, or the memory device 140) when the memory sub-system 110 can be coupled with the host system 120 by the PCIe interface. The physical host interface can provide an interface for passing control, address, data, and other signals between the memory sub-system 110 and the host system 120. FIG. 1A illustrates a memory sub-system 110 as an example. In general, the host system 120 can access multiple memory sub-systems via a same communication connection, multiple separate communication connections, and/or a combination of communication connections.

Each of the memory device(s) 130 of the memory sub-system 110 can be indexed by a set of physical addresses. Physical addresses of the memory device can be stored in an address lookup table. In the illustrated example, address lookup table can be included in the memory sub-system controller 115 as a part of local memory 119 however, the address lookup table can also be a separate component of memory sub-system 110, included in the memory device 130, or can be external to the memory sub-system 110. In some embodiments, the address lookup table can be stored and maintained by address translation component 113. In some embodiments, address translation component 113 can perform the functions of address assignment component 121. Additional details regarding the address assignment component 121 are described herein.

The memory sub-system 110 includes a memory sub-system controller 115 that can communicate with the memory device(s) 130 to perform operations such as reading data, writing data, or erasing data at the memory devices 130 and other such operations. The memory sub-system controller 115 can include hardware such as one or more integrated circuits and/or discrete components, a buffer memory, or a combination thereof. The hardware can include a digital circuitry with dedicated (i.e., hard-coded) logic to perform the operations described herein. The memory sub-system controller 115 can be a microcontroller, special purpose logic circuitry (e.g., a field programmable gate array (FPGA), an application specific integrated circuit (ASIC), etc.), or other suitable processor.

The memory sub-system controller 115 can include a processor 117 (e.g., a processing device) configured to execute instructions stored in a local memory 119. In the illustrated example, the local memory 119 of the memory sub-system controller 115 includes an embedded memory configured to store instructions for performing various processes, operations, logic flows, and routines that control operation of the memory sub-system 110, including handling communications between the memory sub-system 110 and the host system 120.

In some embodiments, the local memory 119 can include memory registers to store memory pointers, fetched data, etc. The local memory 119 can also include read-only memory (ROM) to store micro-code. While the example memory sub-system 110 in FIG. 1A has been illustrated as including the memory sub-system controller 115, in another embodiment of the present disclosure, a memory sub-system 110 does not include a memory sub-system controller 115, and can instead rely on external control (e.g., provided by an external host, or by a processor or controller separate from the memory sub-system).

In general, the memory sub-system controller 115 can receive commands or operations from the host system 120 and can convert the commands or operations into instructions or appropriate commands to achieve the desired access to the memory device(s) 130. The memory sub-system controller 115 can be responsible for other operations such as wear leveling operations, garbage collection operations, error detection and error-correcting code (ECC) operations, encryption operations, caching operations, and address translations between a logical address (e.g., logical block address (LBA), namespace) and a physical address (e.g., physical block address) associated with the memory device(s) 130. The memory sub-system controller 115 can further include host interface circuitry to communicate with the host system 120 via the physical host interface. The host interface circuitry can convert the commands received from the host system into command instructions to access the memory device(s) 130 as well as convert responses associated with the memory device(s) 130 into information for the host system 120.

The memory sub-system 110 can also include additional circuitry or components that are not illustrated. In some embodiments, the memory sub-system 110 can include a cache or buffer (e.g., DRAM) and address circuitry (e.g., a row decoder and a column decoder) that can receive an address from the memory sub-system controller 115 and decode the address to access the memory device(s) 130.

In some embodiments, the memory device(s) 130 include local media controllers 135 that operate in conjunction with memory sub-system controller 115 to execute operations on one or more memory cells of the memory device(s) 130. An external controller (e.g., memory sub-system controller 115) can externally manage the memory device 130 (e.g., perform media management operations on the memory device(s) 130). In some embodiments, a memory device 130 can be a managed memory device, which can be a raw memory device (e.g., memory array 104) having control logic (e.g., local media controller 135) for media management within the same memory device package. An example of a managed memory device can be a managed NAND (MNAND) device. Memory device(s) 130, for example, can each represent a single die having some control logic (e.g., local media controller 135) embodied thereon. In some embodiments, one or more components of memory sub-system 110 can be omitted.

In one embodiment, the computing system 100 can include a virtual address manager 150. When an application of host system 120 requires memory resources (e.g., an assignment of memory addresses), host system 120 can send a request for an assignment of memory address to the virtual address manager 150. Based on the request received from host system 120, the virtual address manager 150 can assign the host system 120 a contiguous set of virtual addresses from the master virtual address table 158. The set of virtual addresses can map to a contiguous set of physical addresses of memory sub-system 110. The master virtual address table 158 can map virtual addresses 1:1 to each physical address in a disaggregated memory pool. For example, in a disaggregated memory pool with two identical memory sub-systems, the master virtual address table 158 can have distinct virtual addresses that map 1:1 to each physical address of the two memory sub-systems. In some embodiments, the virtual address manager 150 can have multiple distinct portions that each correspond to the quantity of physical memory addresses in a respective memory sub-system of a disaggregated memory pool. Referring to the previous example, the master virtual address table 158 for the disaggregated memory pool with ten identical memory sub-systems would thus have two identically sized portions of the master virtual address table 158, with each portion corresponding to the physical addresses of the respective memory sub-systems. Once the host system 120 has received an assignment of virtual addresses from the master virtual address table 158, the host system 120 can communicate directly with the memory sub-system 110 that contains the physical addresses that are contiguously mapped to the assigned virtual addresses. In some embodiments, the virtual address manager 150 can serve as an intermediary between the host systems 120 and memory sub-systems 110 (not illustrated). In such embodiments, the virtual address manager 150 can be implemented in a disaggregated memory switch, such as a CXL switch, as described in the CXL 2.0 and later documentation.

As described above, while computing system 100 includes a single host system 120 and a single memory sub-system 110, additional host systems 120 and/or memory sub-systems 110 can be included. In embodiments of computing system 100 with multiple host systems 120 and multiple memory sub-systems 110, computing system 100 can include a single virtual address manager 150. In some embodiments, virtual address manager 150 can be a part of host system 120. In embodiments of computing system 100 with multiple host systems 120, a single host system 120 can include the virtual address manager 150. The master virtual address table 158 can be generated and stored by virtual address manager 150. The master virtual address table 158 can be a master version of the master virtual address table 158. In some embodiments, each host system 120 of computing system 100 can include a copy of the master virtual address table 158. In some embodiments, the copies of the master virtual address table 158 on each host system 120 can be read-only. In some embodiments the master virtual address table 158 generated by the virtual address manager 150 can be accessible by each host system of the computing system 100.

In one embodiment, computing system 100 includes an address assignment component 121. In the illustrated example, the address assignment component 121 is included in host system 120, however, the address assignment component 121 can be a distinct component of system 100, a distinct component included in memory sub-system 110, and/or a distinct component included in memory sub-system controller 115. Address assignment component 121 can be implemented in any combination of hardware, firmware, and/or software. In some embodiments, address assignment component 121 can be a part of virtual address manager 150. In some embodiments, address assignment component 121 can be a part of address translation component 113 of memory sub-system controller 115. As described above, in some embodiments, address translation component 113 can accept addresses of memory access operations received by the memory sub-system 110, and translate the received addresses into local physical addresses of the memory sub-system 110.

Address assignment component 121 can receive a request for a memory address assignment of memory addresses from an application of a host system. Address assignment component 121 can determine whether virtual addresses from the master virtual address table 158 of the virtual address manager 150 can be assigned to the application. If the address assignment component 121 determines not to assign shared virtual addresses to the application, the address assignment component 121 can indicate to host system 120 that the application should be assigned local host addresses (e.g., virtual addresses corresponding to the physical addresses of the host system). If the address assignment component 121 determines to assign shared virtual addresses to the application, the address assignment component 121 can indicate to host system 120 that the application should be assigned a set of virtual addresses from the pool of shared virtual addresses. In some embodiments, the address assignment component 121 can request a set of virtual addresses from the shared virtual addresses from the virtual address manager 150.

In some embodiments, the address assignment component 121 can determine to assign virtual addresses from a pool of shared virtual addresses if the virtual addresses are to be used by multiple computing elements (e.g., the application and/or application memory is to be shared between systems/components). For example, a request for virtual addresses can indicate the application is to be used by a first host and a second host, and the address assignment component 121 can assign virtual addresses from the pool of shared virtual addresses to the application (e.g., in response to the request for virtual addresses). In another example, the request for virtual addresses can indicate the application is to be used by two components of one or more host systems (e.g., a central processing unit (CPU), a graphics processing unit (GPU), etc.), and the address assignment component 121 can assign virtual addresses from the pool of shared virtual addresses to the application.

In some embodiments, the address assignment component 121 can determine to assign virtual addresses from a pool of shared virtual addresses if the quantity of virtual addresses requested for the allocation exceeds a threshold amount. For example, if an application requests a quantity of addresses greater than a predetermined threshold, the virtual addresses can be assigned from the pool of shared virtual addresses. In another example, if an application requests a quantity of addresses less than a predetermined threshold, the virtual addresses can be assigned from local host addresses (e.g., virtual addresses corresponding to physical addresses of the host from which the application initiates the request). In some embodiments, the address assignment component 121 can receive an explicit request by an application for addresses from the pool of shared virtual addresses. In some embodiments, the address assignment component 121 can receive an explicit request from an application for addresses from the local host addresses (e.g., virtual addresses corresponding to physical addresses of the host from which the application initiates the request. For example, the quantity of virtual addresses requested may exceed a quantity of virtual addresses corresponding to physical addresses of a host system (e.g., the host system may not have a large enough memory to fulfill the memory request for the application). In such examples, the address assignment component 121 can assign virtual addresses from the pool of shared virtual addresses to the application in response to the received request.

In some embodiments, the address assignment component 121 can determine to assign virtual addresses from the pool of shared virtual addresses based on memory latency requirements for the application. For example, if an application has a low latency memory requirement, the address assignment component 121 can assign virtual addresses from the memory device of the host system (e.g., virtual addresses corresponding to physical memory addresses in the host system). In another example, the latency of accessing virtual addresses on a host device can be higher than the latency of accessing virtual addresses from the pool of shared virtual addresses, and the address assignment component 121 can assign virtual addresses from the pool of shared virtual addresses to the application in response to the received request. Further details with regards to the operations of address assignment component 121 are described below.

FIG. 1B is a block diagram of a computing environment 160 of a disaggregated memory environment, in accordance with aspects of the present disclosure. In the illustrated example, computing environment 160 illustrates host system 120A, host system 120B, memory device 130A, and memory device 130B, and virtual address manager 150. For clarity, some features are not illustrated in FIG. 1B (e.g., the address assignment component 121 of host system 120 as described with respect to FIG. 1A, and memory sub-systems 110 that would each respectively include memory device 130A and memory device 130B).

Host systems 120A and 120B can be host systems 120 as described with respect to FIG. 1A. Host system 120A can include host memory 129A and duplicate virtual address table 159A. Host system 120B can include host memory 129B and host address table 128B. Host systems 120 can interface with any memory sub-system in a disaggregated memory environment (e.g., a memory sub-system that includes memory device 130A or a memory sub-system that includes memory device 130B).

Memory devices 130A and 130B can be memory devices 130 as described with respect to FIG. 1A. Memory devices 130A and 130B can include physical addresses 131A and 131B respectively. In some embodiments, physical addresses 131 can represent addresses of memory cells in memory array 104 as described with respect to FIG. 1A. In some embodiments, physical addresses 131 can represent addresses for storing data in other ways, such as chemically, magnetically, or otherwise.

Virtual address manager 150 includes master virtual address table 158, as described above with respect to FIG. 1A. When a set of virtual addresses is assigned to an application of a host system 120, virtual address manager 150 can indicate the memory address assignment in the master virtual address table 158. The master virtual address table 158 can include sub-divisions of virtual addresses that map to respective physical addresses. In the illustrative example, memory device virtual addresses 151A are a sub-division of virtual addresses that map to physical addresses 131A of memory device 130A. Similarly, memory device virtual addresses 151B map to physical addresses 131B, virtual pooling addresses 153A and 153B map to host pooling addresses 123A and 123B respectively, and local address reserves 154A and 154B map to local host addresses 124A and 124B respectively.

Master virtual address table 158 can represent a single contiguous virtual address translation scheme for all physical addresses available in a disaggregated memory pool. When a host system 120 requests virtual addresses, virtual address manager 150 can use the master virtual address table 158 to assign a contiguous set of physical addresses associated with the disaggregated memory pool. When virtual addresses have been assigned to a host system 120, the corresponding physical addresses of a respective memory sub-system (not illustrated) or a respective host (e.g., host pooling addresses 123A of host system 120A or host pooling addresses 123B of host system 120B in the illustrated example) can be assigned to the host system 120. In some embodiments, an assignment of virtual addresses can be considered an allocation of memory (e.g., a memory allocation). In some embodiments, the assignment of virtual addresses can be reflected in the master virtual address table 158 by indicating, for each virtual address or group of virtual addresses, a host identification, and an application identification. In some embodiments, virtual addresses and physical addresses can be assigned in discrete groups or “units.” The size of units used to assign memory addresses can be the same for both the virtual addresses and the physical addresses. For example, virtual addresses in a master virtual address table 158 might be assigned in one gigabyte units (e.g., by the number of virtual addresses needed to store one gigabyte of data). In such embodiments, the size of the master virtual address table 158 can be reduced significantly, based on the size selected for each unit. It should be noted that while master virtual address table 158 illustrates memory device virtual addresses 151 grouped together and preceding virtual pooling addresses 153 and local address reserves 154, any arrangement of the subparts of the master virtual address table 158 (e.g., sequential numbering of virtual addresses) that correspond to respective physical addresses is possible.

When a host system 120 requests virtual addresses from virtual address manager 150, virtual address manager can assign virtual addresses from memory device virtual addresses 151A and 151B, or virtual pooling addresses 153A and 153B. Virtual address manager 150 cannot assign virtual addresses from local address reserves 154A or 154B to the host system 120. In some embodiments, master virtual address table 158 does not include local address reserves 154A and 154B. That is, virtual address manager can identify host memory 129 as only including host pooling addresses 123A. In some embodiments, the master virtual address table 158 can include virtual addresses that map to local host addresses 124 (e.g., local address reserves 154 in the illustrated example), but do not store an indication of memory address assignments that have been made to local host addresses 124. In some embodiments, master virtual address table 158 can include local address reserves 154 that store indications of memory address assignments made in local address reserves 154. In such embodiments, host systems 120 can update the local address reserves 154 of master virtual address table 158 at the indication of a host system 120. After a host system 120 has assigned local host addresses 124 to an application, host system can indicate to the virtual address manager 150 what memory address assignment was made, and the virtual address manager 150 can update the master virtual address table 158.

Host systems 120 and other components of computing environment 160 (e.g., not illustrated memory sub-systems) can maintain individual address tables (e.g., such as duplicate virtual address table 159, or host address table 128) with a uniform contiguous address translation scheme. That is, the number of virtual addresses in computing environment 160 can be equivalent to the number of physical addresses in computing environment 160, and each physical address of a host system can map to a unique virtual address. Therefore, while components of computing environment 160 can maintain individual address tables, the addresses in each individual address table can be consistent with the master virtual address table 158. For example, if in the illustrated example, the memory device virtual addresses 151A start at 0x0001 and end at 0x2000, the memory device virtual addresses 151B start at 0x2001 and end at 0x4000, the virtual pooling addresses 153A start at 0x4001 and end at 0x5000, address translation tables stored on a respective host system will each reflect the same global virtual addresses. That is, the addresses in an address table for host pooling addresses 123A on host system 120A will start at virtual address 0x4001 and end at 0x5000, and the addresses in an address table for physical addresses 131B will start at virtual address 0x2001 and end at 0x4000. In this way, a global virtual address translation scheme can be a constant across components of computing environment 160.

In some embodiments, host systems 120 can indicate a memory address assignment of local host addresses 124 in a duplicate virtual address table 159 stored on the host system 120. Duplicate virtual address table 159 can be a copy of the master virtual address table 158, and can be updated periodically. In some embodiments, duplicate virtual address table 159 can be updated in response to a triggering event, such as an assignment or un-assignment of virtual memory addresses. With the exception of the local address reserve 154 that corresponds to the respective host system 120, duplicate virtual address tables 159 can be a read-only data structure (e.g., non-editable by host systems 120). In the illustrated example, host system 120A cannot make or change memory address assignments in the duplicate virtual address table 159A that are highlighted (e.g., memory device virtual addresses 151A and 151B, virtual pooling addresses 153A and 153B, and local address reserve 154B). Host system 120A can make or change memory address assignments in the local address reserve 154A in the duplicate virtual address table 159A.

In some embodiments, host systems 120 can indicate an assignment of local host addresses 124 in a host address table 128. The host address table 128 can reflect the assignments of physical memory addresses of the respective host system 120. In the illustrated example, host system 120B includes host memory 129B, with host pooling addresses 123B and local host addresses 124B. Host system 120B also includes host address table 128B, with virtual pooling addresses 153B and local address reserve 154B. Host system 120B cannot make or change assignments of virtual pooling addresses 153B, which reflect entries in the master virtual address table 158. When host system 120B receives a request for an assignment of local host addresses 124B, host system 120B can assign physical addresses of the local host addresses 124A and store an indication of the memory address assignment in the local address reserve 154B. Virtual address manager 150 can request that host systems 120 send updated versions of local address reserve 154 to the virtual address manager 150 to be reflected in the master virtual address table 158.

In some embodiments, master virtual address table 158 can be partially decentralized. Virtual address manager 150 can update and maintain global virtual address entries in the master virtual address table 158 (e.g., memory device virtual addresses 151A and 151B, and virtual pooling addresses 153A and 153B), whereas host systems 120 can update and maintain local virtual address entries (e.g., local address reserves 154A and 154B). Master virtual address table 158 can be centrally accessible to multiple host systems 120, and individual host systems 120 might not include a duplicate virtual address table 159 or a host address table 128. In such embodiments, all memory address assignments are reflected in the master virtual address table 158. Virtual addresses can be assigned by the virtual address manager 150. Local host addresses 124 corresponding to local address reserves 154 can be assigned by respective host systems 120. That is, the contents (e.g., entries) in the master virtual address table 158 that correspond to virtual addresses can be updated by the virtual address manager 150, and entries in the master virtual address table 158 that correspond to local address reserves 154 can be updated by respective host systems 120.

FIG. 1C is a block diagram of computing environment 190 of a disaggregated memory environment, in accordance with aspects of the present disclosure. In the illustrated example, computing environment 190 illustrates host system 120C, memory device 130C, and virtual address manager 150. For clarity, some features are not illustrated in FIG. 1C (e.g., a memory sub-system 110 as described with respect to FIG. 1A that would include memory device 130C).

Host system 120C can be a host system 120 as described with respect to FIGS. 1A-B. In the illustrated example, host system 120C includes Application I 127A, Application II 127B, and Application III 127C. The Applications I, II, and III (127A, 127B, and 127C respectively) can refer to software applications that are performed by, or on a host system 120C. In some embodiments, applications 127 can refer to a computer process, or execution thread of a compute unit. Applications 127 can request addresses to store data for temporary use or longer-term use. For example, applications 127 can request addresses of volatile memory for performing processing instruction sets, or preloading temporary data. In another example, applications 127 can request addresses of non-volatile memory for storage of data when a power source is removed.

Memory device 130C can be a memory device 130 as described with respect to FIGS. 1A-B. Memory device 130C can include physical addresses 131C. In some embodiments, physical addresses 131 can represent addresses of memory cells in memory array 104 as described with respect to FIG. 1A. In some embodiments, physical addresses 131 can represent addresses for storing data in other ways, such as chemically, magnetically, or otherwise.

Virtual address manager 150 includes master virtual address table 158, as described above with respect to FIGS. 1A-1B. Addresses assigned to applications 127 of host systems 120 can be reflected in the master virtual address table 158. An application 127 can request memory resources (e.g., a memory address assignment) from the host system 120C. In the illustrated example, a request for a memory address assignment from applications 127 of host system 120C is received by address assignment component 121. As described above, the address assignment component 121 can determine whether the memory address assignment should come from virtual addresses corresponding to local host addresses (e.g., local host addresses 124C) or from virtual addresses from a shared virtual address pool. For example, and in some embodiments, requests for larger quantities of virtual memory allocations (e.g., quantities of virtual addresses that exceed a threshold) can be assigned virtual addresses from the pool of shared virtual addresses. When address assignment component 121 determines that the memory address assignment should come from virtual addresses corresponding to the local host addresses 124C, host system 120C can update the local reserve addresses 153C of master virtual address table 158 that map to local host addresses 124C to indicate the memory address assignment. When address assignment component 121 determines that the memory address assignment should come from shared memory addresses, the address assignment component 121 can request virtual addresses from the pool of shared virtual addresses (e.g., using the virtual address manager 150) for the respective application. Thereafter, the application 127 can, through host system 120, communicate directly with the component of computing environment 190 that contains the respective physical addresses that map to the assigned virtual addresses.

In the illustrated example, Application I 127A requests an assignment of memory addresses. Address assignment component 121 determines the memory address assignment can be from virtual addresses, and assigns virtual addresses (e.g., Application I addresses 157A) from memory device virtual addresses 151C. Thereafter, for the duration of the assignment of Application I addresses 157A, host system 120C can communicate directly with memory device 130C, which contains the physical addresses that map to the assigned virtual addresses of Application I addresses 157A. In the illustrated example, Application II 127B is assigned virtual addresses (e.g., Application II addresses 157B) that map to physical addresses of the host system 120C, host pooling addresses 123C. In some embodiments, Applications 127 can be assigned virtual addresses that map to physical addresses of other host systems 120 (not illustrated, e.g., other host pooling addresses 123). In the illustrated example, Application III 127C is assigned local host addresses 124C which can be reflected at entries of the master virtual address table 158 that correspond to the respective local host addresses 124C (e.g., Application III addresses 157C).

In the illustrated example, address assignment component 121 is part of host system 120. As described above, however, address assignment components can be included as a distinct component of computing environment 190, included in virtual address manager 150, or in respective memory sub-systems (e.g., memory sub-systems 110). In some embodiments, the function of address assignment component 121 can be performed by other components of host system 120, or other components of computing environment 190.

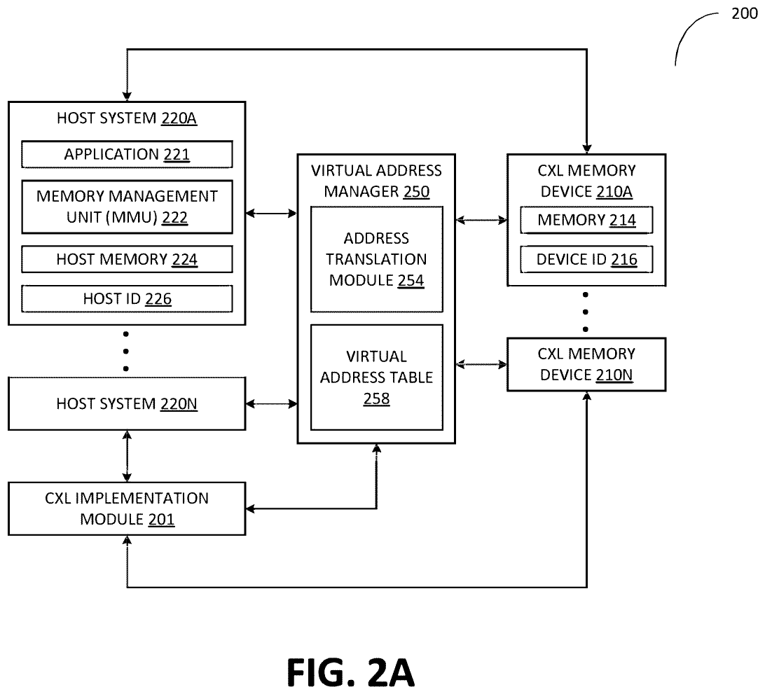

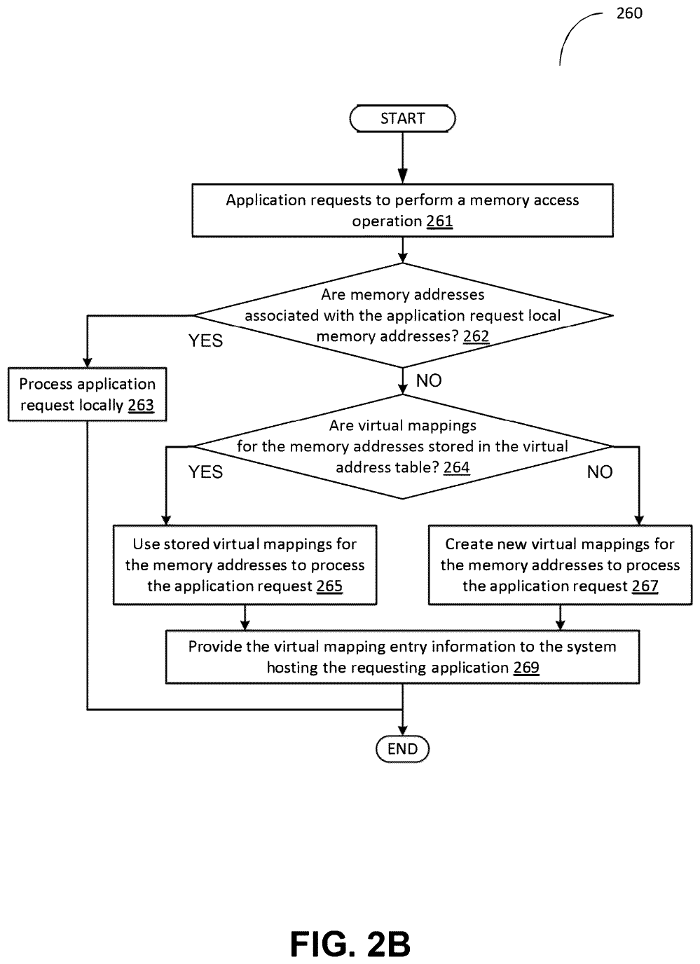

FIG. 2A illustrates an example of a disaggregated memory environment 200 that includes a virtual address manager 250. In some embodiments, the virtual address manager 250 can be a virtual address manager 150 described with reference to FIGS. 1A-B. The virtual address manager 250 can be one of the computing devices including the disaggregated memory environment 200. Examples of such computing devices can include a desktop computer, laptop computer, network server, mobile device, a vehicle (e.g., airplane, drone, train, automobile, or other conveyance), Internet of Things (IoT) enabled device, embedded computer (e.g., one included in a vehicle, industrial equipment, or a networked commercial device), or such computing device that includes memory and a processing device. FIG. 2A illustrates one example of a virtual address manager 250 coupled to one or more CXL memory devices 210A-N (also referred to singularly herein as “CXL memory device 210”) and host systems 220A-N (also referred to singularly herein as “host system 220”). CXL memory devices 210A-N can also be directly coupled to host systems 220A-N. Additionally, host systems 220A-N, CXL memory device 210A-N, and virtual address manager 250 can be coupled to other components of disaggregated memory environment 200 through CXL implementation module 201.

CXL implementation module 201 can be a CXL switch, CXL fabric manager, or other component used to implement and/or facilitate CXL communications within the disaggregated memory environment 200. CXL implementation module 201 can be included in any of host systems 220A-N or other components of disaggregated memory environment 200, or as in the illustrated example, can be a standalone component of disaggregated memory environment 200. In some embodiments, CXL implementation module 201 can include and perform the operations of virtual address manager 250. CXL implementation module 201 can refer to any combination of a hardware, firmware, or software module.

In some embodiments, logic within the CXL implementation module 201 can transform the virtual memory address to a physical address (or vice versa). The translation from a virtual address to a physical address can include two general steps. First, determining whether the address is a local address or a non-local address, and second, mapping the address based on the local/non-local determination of the first step. A memory management unit (MMU) associated with a host (e.g., memory management unit 222 of host system 220) can determine whether the virtual address maps to an address in the virtual global address pool (e.g., first step) and if so, whether it maps to a local segment or a remote segment (e.g., a segment on the host system 220, or a segment on another host system such as host system 220N, or CXL memory device 210A-N). If the address maps to a local segment, the MMU can map the virtual address to a local physical address (e.g., second step); if the address maps to a remote segment, the request can be forwarded to the CXL implementation module 201 (or virtual address manager 250) to determine which remote device hosts the target segment (e.g., host system 220N, CXL memory devices 210A-N, etc.). Once the remote device has been determined, the request can be sent to the appropriate physical device. Additional details regarding logic pertaining to fulfilling a memory access request in the disaggregated memory environment 200 are described with reference to FIG. 2B.

CXL memory device 210 can refer to a memory device in a disaggregated memory environment 200 that is configured to provide memory resources (e.g., memory 214) as a part of a shared memory pool, per the CXL protocol. In some embodiments, the CXL memory device 210 can be a memory sub-system 110 as described with reference to FIG. 1A, and memory 214 can be a memory device 130. CXL memory device 210 includes a device ID 216. Device ID 216 can include both a physical device ID and a virtual device ID. The physical device ID can be a unique physical ID that was assigned to the CXL memory device 210 during production of the CXL memory device 210, and is non-configurable (e.g., read-only). The virtual device ID can be a unique virtual ID that is assigned by the virtual address manager 250 and/or the CXL implementation module 201. The device ID 216 can be used to construct a memory address for data stored at memory 214 of the CXL memory device 210A. For example, virtual address manager 250 can use the virtual device ID as a part of the virtual addresses assigned to the physical memory addresses of memory 214.

Host system 220 can refer to a system in a disaggregated memory environment 200 configured to perform certain operations, including hosting the application 221. In some embodiments, host system 220 can be a host system 120 as described with reference to FIGS. 1A-B. Host system 220 includes application 221 (e.g., hosts, or performs application 221), memory management unit 222, host memory 224, and host ID 226.

Application 221 can be an application such as application III 127A, application III 127B, or application III 127C as described with reference to FIG. 1B. When application 221 requests to perform a memory access operation (e.g., read data from memory, write data to memory, etc.), the memory access operation request can be sent to memory management unit 222. Memory management unit 222 can determine whether the memory address provided by the application 221 corresponds to a global shared memory region (e.g., memory addressable by virtual addresses of the virtual address table 258) or to host memory 224. If the memory address in the request corresponds to host memory 224, the host system 220 processes the command without using the virtual address manager 250. If the memory address in the request does not correspond to host memory 224, the host system 220 (via memory management unit 222) sends the memory access operation request to the virtual address manager 250 for processing. In some embodiments, if the memory address in the request does not correspond to host memory 224, memory management unit 222 can check a local address cache to determine whether the virtual memory address mapping is stored in the local address cache. If the cache includes a virtual memory address mapping for the memory address in the request, the host system 220 can process the request by sending the request to the appropriate physical component that corresponds to the memory address in the request (e.g., another host system (e.g., host system 220N), a CXL memory device 210A-N, etc.) and receiving back the requested data.

In some embodiments, the memory management unit 222 can determine whether the memory address corresponds to the host memory 224 based on the host ID 226 and/or the device ID 216 encoded in the memory address. For example, the memory address can include an indicator that the memory address is a virtual address and an indicator of the device ID 216. In some embodiments, the memory address can include an indicator that the device ID 216 is a virtual device ID. In some embodiments, the virtual device ID in a memory address can be replaced with a corresponding physical device ID to convert the virtual address into a physical address. If there is no device ID 216 indicated in the memory address, or if, when sent to the virtual address manager 250, no device ID 216 corresponds to the request, the virtual address manager 250 can assign a set of virtual addresses to the memory request and a corresponding unique global ID to the set of virtual addresses. This assignment of virtual addresses is described above with reference to FIG. 1B.

Virtual address manager 250, as previously described, can be a virtual address manager 150 as described with reference to FIGS. 1A-B, and can be included in any of host system 220A-N (not illustrated). When the virtual address manager 250 receives a memory access operation request (e.g., from host system 220), the address translation module 254 can translate the memory address provided by the host system 220 from a physical address into a virtual address. In some embodiments, the address translation module 254 can systematically check the virtual address table 258 for entries corresponding to a received memory access request. In some embodiments, the virtual address table 258 can include various fields such as a register identifier, a bit quantity, a bit offset, a field type, and a description of virtual memory addresses and/or virtual memory address operations for the global virtual memory address pool. In some embodiments, the address translation module 254 can translate the received memory address into a fabric physical address to be used by CXL implementation module 201 to determine routing information for routing the physical address to the proper destination device. In some embodiments, once the virtual address manager 250 has assigned a set of virtual memory addresses and/or properly routed a memory access request from a host system 220, the virtual address manager 250 can indicate to the host system a mapping between the physical memory address and the associated virtual memory address. The host system 220 can then store the mapping in a cache for later use. Virtual address mappings stored in a cache on the host system 220 enable the host system 220 to bypass the virtual address manager 250 (and/or the CXL implementation module) and directly communicate the memory access request to the physical component associated with the memory addresses of the memory request (e.g., another host system such as host system 220N, a CXL memory device 210A-N, etc.).

FIG. 2B is a flow diagram of an example of a method 260 of a memory sub-system aware prefetching, in accordance with aspects of the present disclosure. The method 260 can be performed by processing logic that can include hardware (e.g., processing device, circuitry, dedicated logic, programmable logic, microcode, hardware of a device, integrated circuit, etc.), software (e.g., instructions run or executed on a processing device), or a combination thereof. In some embodiments, the processing logic can be performed by a processing device that is operatively coupled to the memory device. In some embodiments, the method 260 is performed by various components in a disaggregated memory environment 200 of FIG. 2A. Although illustrated in a particular sequence or order, unless otherwise specified, the order of the processes can be modified. Thus, the illustrated embodiments should be understood only as examples, and the illustrated processes can be performed in a different order, and some processes can be performed in parallel. Additionally, one or more processes can be omitted in various embodiments. Thus, not all processes are required in every embodiment. Other process flows are possible.

At operation 261, an application requests to perform a memory access operation. As described above with reference to FIG. 1B, the application can be hosted on a host system, and the memory access operations can include operations such as read operations, write operations, erase operations, etc.

At operation 262, processing logic (e.g., a memory management unit associated with the application) determines whether the memory addresses associated with the application request are local memory addresses (e.g., memory addresses of the host performing the application). Responsive to determining the memory addresses associated with the application request are local memory addresses (“YES”), the method can proceed to operation 263. Responsive to determining the memory addresses associated with the application request are not local memory addresses (“NO”), the method can proceed to operation 264.

At operation 263, responsive to determining that the memory addresses associated with the application request are local memory addresses, the application request can be processed locally, after which the method can be terminated.

At operation 264, responsive to determining the memory addresses associated with the application request are not local memory addresses, the memory request can be sent to the virtual address manager 250, and processing logic (e.g., address translation module 254) can determine whether there are virtual mappings for the memory addresses stored in the virtual address table 258. Responsive to determining if there are virtual mappings for the memory addresses associated with the application request in the virtual address table 258 (“YES”), the method can proceed to operation 265. Responsive to determining there are not virtual mappings for the memory addresses associated with the application request in the virtual address table 258 (“NO”), the method can proceed to operation 267.

At operation 265, responsive to determining there are virtual mappings for the memory addresses associated with the application request in the virtual address table 258, the respective stored virtual mappings in the virtual address table 258 can be used to process the application request.

At operation 267, responsive to determining there are not virtual mappings for the memory addresses associated with the application request in the virtual address table 258, processing logic (e.g., address translation module 254) can create new virtual mappings for the memory addresses to process the application request.

At operation 269, processing logic of the virtual address manager 250 (e.g., address translation module 254) can provide virtual mapping entry information to the system hosting the requesting application (e.g., host system 220). Subsequently, processing logic of the host system 220 (e.g., memory management unit 222) can process the application request based on the information provided by the virtual address manager 250. In some embodiments, the virtual mapping information provided by the virtual address manager 250 can be stored in a cache associated with the memory management unit. In alternative embodiments, the application request can be performed in full or in part by the virtual address manager 250, and/or CXL implementation module 201. Upon performing the application request, the method can be terminated.

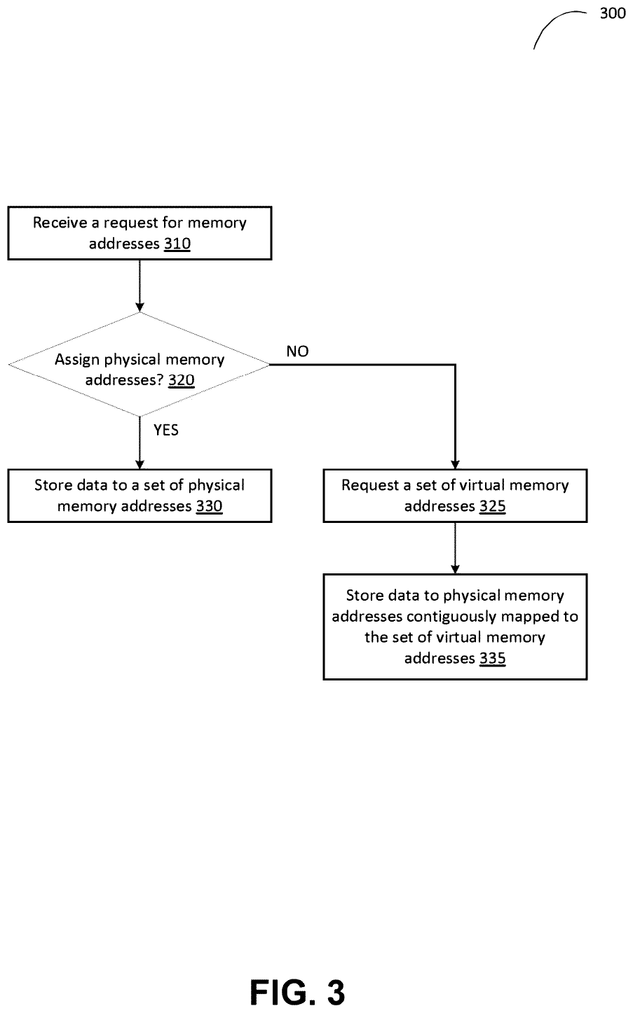

FIG. 3 is a flow diagram of an example method 300 of a concurrent address translation scheme in a disaggregated memory environment, in accordance with aspects of the present disclosure. The method 300 can be performed by processing logic that can include hardware (e.g., processing device, circuitry, dedicated logic, programmable logic, microcode, hardware of a device, integrated circuit, etc.), software (e.g., instructions run or executed on a processing device), or a combination thereof. In some embodiments, the method 300 is performed by address assignment component 121 of FIG. 1A and FIG. 1C, and/or the address translation component 113 of FIG. 1A. Although illustrated in a particular sequence or order, unless otherwise specified, the order of the processes can be modified. Thus, the illustrated embodiments should be understood only as examples, and the illustrated processes can be performed in a different order, and some processes can be performed in parallel. Additionally, one or more processes can be omitted in various embodiments. Thus, not all processes are required in every embodiment. Other process flows are possible.

At operation 310, the processing logic (e.g., address assignment component 121) receives a request for memory addresses. The request can be received from an application of a host associated with the memory device (e.g., the memory device is part of the host system). In some embodiments, the request can be received from an application of another host in a disaggregated memory environment. The request can indicate that the application is compatible with a virtual addressing scheme. In some embodiments, if the request does not indicate that the application is compatible with a virtual addressing scheme, processing logic will not use the virtual addressing scheme for the application.

At operation 320, the processing logic determines whether to assign physical memory addresses to fulfill the request for memory addresses. In some embodiments, this determination can be made based on the contents of the request. As described above with reference to operation 310, the request can indicate the application is compatible with a virtual addressing scheme. In some embodiments, the indication can be a particular set bit in a memory address associated with the request. For example, in a 64-bit memory address, the first 57 bits (e.g., bits 0-56) can be used to identify a memory address, and the remaining 7 bits (e.g., bits 57-63) can be used to convey additional information. Thus, in such an example, bit 57 might be selected as an indicator as to whether the application supports a virtual addressing scheme (e.g., physical addresses will not be assigned). A high value (e.g., “1”) can indicate the application supports the virtual addressing scheme. In some embodiments, the request can indicate the application is compatible with a virtual addressing scheme when an address associated with the request falls within a range of physical addresses that contiguously map to a contiguous set of virtual addresses.

At operation 330, responsive to determining to assign physical memory addresses to fulfill the request for memory addresses, processing logic stores data to a set of physical memory addresses. Physical memory addresses can be assigned for a request (e.g., assigned to an application of a host system) when the application does not support virtual addressing. In some embodiments, applications and requests from applications can be modified to support virtual addressing. In some embodiments, an intermediate component or process can modify the request from an application to support virtual addressing.

At operation 325, responsive to determining not to assign physical memory addresses to fulfill the request for memory addresses, processing logic requests a set of virtual memory addresses. The set of virtual addresses can be requested from a global allocator (e.g., such as virtual address manager 150 as described with respect to FIGS. 1A-1C). Virtual addresses can contiguously map to physical addresses in a disaggregated memory environment. In some embodiments, the set of virtual addresses can contiguously map to physical addresses of the memory device. In some embodiments, the set of virtual addresses can contiguously map to physical addresses of another memory device in the disaggregated memory environment.

At operation 335, processing logic stores data to physical memory addresses contiguously mapped to the set of virtual memory addresses. Data can be stored to physical addresses of a device or system in the disaggregated memory environment. In some embodiments, the data stored to the physical addresses can be globally addressable by the virtual addresses. That is, each physical address of a disaggregated memory environment can have a unique virtual address. Virtual addresses for a disaggregated memory pool can be managed by a global allocator (e.g., virtual address manager 150 as described with respect to FIGS. 1A-1C). Virtual addresses for physical portions of memory devices local to a host (e.g., physical addresses that are not part of the disaggregated memory pool) can be managed by respective hosts.

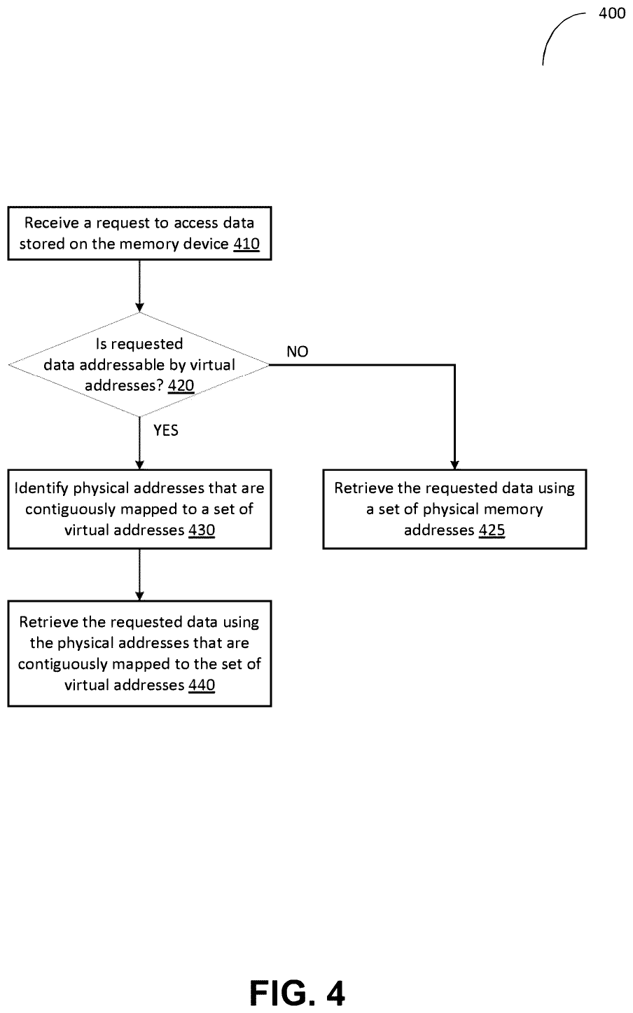

FIG. 4 is a flow diagram of an example method 400 of a concurrent address translation scheme in a disaggregated memory environment, in accordance with aspects of the present disclosure. The method 400 can be performed by processing logic that can include hardware (e.g., processing device, circuitry, dedicated logic, programmable logic, microcode, hardware of a device, integrated circuit, etc.), software (e.g., instructions run or executed on a processing device), or a combination thereof. In some embodiments, the method 400 is performed by address assignment component 121 of FIG. 1A and FIG. 1C, and/or the address translation component 113 of FIG. 1A. Although illustrated in a particular sequence or order, unless otherwise specified, the order of the processes can be modified. Thus, the illustrated embodiments should be understood only as examples, and the illustrated processes can be performed in a different order, and some processes can be performed in parallel. Additionally, one or more processes can be omitted in various embodiments. Thus, not all processes are required in every embodiment. Other process flows are possible.

At operation 410, the processing logic (e.g., address assignment component 121) receives a request to access data stored on the memory device. In some embodiments, processing logic can receive more than one request to access data stored on the memory device. Each received request can pertain to respective applications of one or more host systems in a disaggregated memory environment.

At operation 420, the processing logic determines whether the requested data is addressable by virtual addresses. In some embodiments, processing logic can determine the requested data is addressable by virtual addresses based on a set bit of an address associated with the request. For example, in a 64-bit memory address, the first 57 bits (e.g., bits 0-56) can be used to identify a memory address, and the remaining 7 bits (e.g., bits 57-63) can be used to convey additional information. Thus, in such an example, bit 57 might be selected as an indicator as to whether the application supports a virtual addressing scheme (e.g., physical addresses will not be assigned). A high value (e.g., “1”) can indicate the application supports the virtual addressing scheme. In some embodiments, processing logic can determine the requested data is addressable by virtual addresses if the request indicates an address that falls within a range of physical addresses that contiguously map to a contiguous set of virtual addresses. For example, a memory device with 0x4000 physical addresses can be divided into two ranges of addresses: a lower range of 0x0000-0x1FFF, and an upper range of 0x2000-0x3FFF that contiguously maps to virtual addresses. In such an example, if the address of the incoming request includes the address 0x3000, then processing logic would determine the requested data is addressable by virtual addresses.

At operation 430, responsive to determining the data is addressable by virtual addresses, processing logic identifies physical addresses that are contiguously mapped to a set of virtual addresses. The processing logic can identify the corresponding physical addresses using an address table stored on-or associated with-the memory device (e.g., such as duplicate virtual address table 159 or host address table 128 as described with respect to FIG. 1B). In some embodiments, the processing logic access a partially decentralized table (e.g., such as master virtual address table 158) to identify physical addresses that are contiguously mapped to the respective virtual addresses of a memory request. In some embodiments, as described above, all physical addresses in a disaggregated memory environment can have a unique virtual address. Assignments of physical addresses that map to virtual addresses in the disaggregated memory pool (e.g., shared memory resources) can be managed by the global allocator (e.g., virtual address manager 150 as described with respect to FIGS. 1A-1C). Assignments of physical addresses that do not map to virtual addresses in the disaggregated memory pool (e.g., local, or host memory resources) can be managed by respective host systems.

At operation 440, processing logic retrieves the requested data using the physical addresses that are contiguously mapped to the set of virtual addresses. In some embodiments, the physical addressing scheme of a host system can be based on the virtual addressing scheme of a global allocator (e.g., virtual address manager 150 as described with respect to FIGS. 1A-1C). In such embodiments, a unique virtual address is assigned to each physical address, and each host system stores physical addresses based on the virtual addresses that contiguously map to the physical addresses of the host system. For example, if the physical addresses of a host system contiguously map to virtual addresses 0x2000-0x2FFF, the host system can begin sequential physical address numbering (e.g., in a local address translation table) at 0x2000, and end at 0x2FFF.

At operation 425, responsive to determining the data is not addressable by virtual addresses in operation 420, processing logic retrieves the requested data using a set of physical addresses.

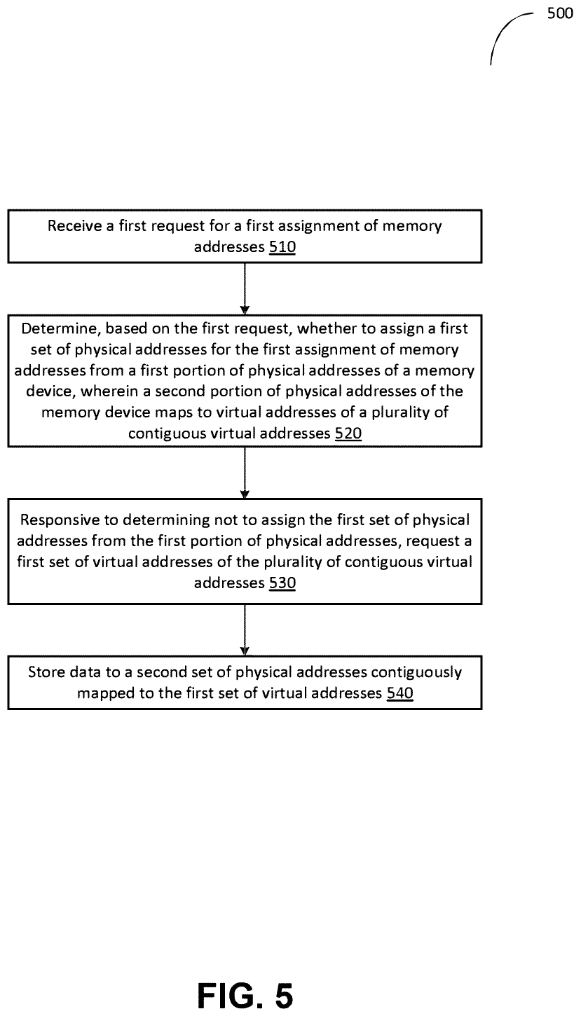

FIG. 5 is a flow diagram of an example method 500 of a concurrent address translation scheme in a disaggregated memory environment, in accordance with aspects of the present disclosure. The method 500 can be performed by processing logic that can include hardware (e.g., processing device, circuitry, dedicated logic, programmable logic, microcode, hardware of a device, integrated circuit, etc.), software (e.g., instructions run or executed on a processing device), or a combination thereof. In some embodiments, the method 500 is performed by address assignment component 121 of FIG. 1A and FIG. 1C, and/or the address translation component 113 of FIG. 1A. Although illustrated in a particular sequence or order, unless otherwise specified, the order of the processes can be modified. Thus, the illustrated embodiments should be understood only as examples, and the illustrated processes can be performed in a different order, and some processes can be performed in parallel. Additionally, one or more processes can be omitted in various embodiments. Thus, not all processes are required in every embodiment. Other process flows are possible.

At operation 510, the processing logic (e.g., address assignment component 121) receives a first request for a first assignment of memory addresses. In some embodiments, processing logic can receive a second request for a set of memory addresses. In some embodiments, the first request and the second request can pertain to a first application of the system. In some embodiments, the first request and the second request can pertain to a first application and a second application. In some embodiments, processing logic can receive a third request.

At operation 520, the processing logic determines, based on the first request, whether to assign a first set of physical addresses of a first portion of physical addresses of a memory device as the first set of memory addresses. In some embodiments, a third request pertains to a third set of physical addresses.

At operation 530, responsive to determining not to assign the first set of physical addresses, processing logic requests a first set of virtual addresses of a plurality of contiguous virtual addresses, wherein a first portion of virtual addresses of the plurality of contiguous virtual addresses contiguously maps to a second portion of physical addresses of the memory device (e.g., set of physical addresses of the memory device maps to virtual addresses of the plurality of contiguous virtual addresses). In some embodiments, the second portion of physical addresses can include the second set of physical addresses. That is, the set of physical addresses that map to the first set of virtual addresses can be physical addresses of the memory device.

At operation 540, responsive to receiving the first set of virtual addresses, the processing logic stores data to a second subset of physical addresses contiguously mapped to the first set of virtual addresses. In some embodiments, as previously described, the first set of virtual addresses can map to physical addresses of the same memory device. In some embodiments, the first set of virtual addresses can map to physical addresses of another memory device (e.g., another memory device in the disaggregated memory environment).

When processing logic receives a request to access data stored at physical addresses of a memory device, the processing logic can determine, based on the request, that the data is addressable by virtual addresses that map to physical addresses of the memory device. For example, the request can be received as a virtual address, and an address translation component (e.g., address translation component 113 as described with respect to FIG. 1A) can translate the virtual address into a local physical address of the memory device. After the address is translated into the local physical address, the memory device can process the memory access operation using the local physical address instead of the virtual address. In some embodiments, the memory device address table (e.g., of address translation component 113) can reflect virtual addresses. For example, as described above, if the virtual addresses that map to the physical addresses of a memory device (or host memory) start at 0x4001 and end at 0x8000, the memory device address table can use the same address values for the physical addresses and start the memory device address table at 0x4001 and end the address table at 0x8000. In this way, the memory address scheme can be consistent across components of the disaggregated memory environment.

In some embodiments, processing logic can determine that the first data is addressable by the first set of virtual addresses by determining the value of a set bit of an address of the request. The set bit can indicate that the first data is addressable by virtual addresses. The set bit can be a predetermined bit tacked onto the end of an address. For example, in addresses that have 64 bits, only bits 0-56 might be used, leaving bits 57-63 available. In this example, the set bit can be a value of one of the available bits 57-63. In some embodiments, processing logic can determine that the first data is addressable by the first set of virtual addresses by determining that an address of the request is within an address range. The address range can indicate the data is addressable by virtual addresses.

The plurality of contiguous virtual addresses can be stored in a global address translation table. The global address translation table can be generated and maintained by a global allocator (e.g., a virtual address manager as described with respect to FIGS. 1A-C). The global allocator can be a distinct component of a disaggregated memory environment, or can be included in a host system. In some embodiments, the global allocator can directly couple to memory sub-systems and/or host systems of a disaggregated memory environment (e.g., the global allocator can communicate directly with the memory sub-systems/and or host systems). In some embodiments, the global allocator can be included in an intermediate component between host systems and memory sub-systems (e.g., such as a switch). In some embodiments, the global allocator can indicate to a host system how the host system can communicate with memory sub-system(s) (e.g., by identifying and assigning to the host system, virtual memory addresses that map to physical addresses of respective memory sub-systems). Once the host system has been assigned virtual memory addresses (e.g., has the information enabling the host system to communicate with respective memory sub-systems), to access data at the virtual memory addresses, the host system can communicate directly with the respective memory sub-system.

In some embodiments, a bit mask vector can be associated with the global address translation table. In some embodiments, the bit mask vector can be stored on, and managed by the global allocator (e.g., virtual address manager 150 as described with respect to FIGS. 1A-1C). In some embodiments, the bit mask vector, or respective portions of the bit mask vector, can be stored at each host system. Each entry in the bit mask vector can indicate whether a respective set of virtual addresses of the contiguous virtual addresses are assigned to an application. In at least one embodiment, the memory device is a cache coupled to a compute unit. The cache can include processor instruction sets for the compute unit.

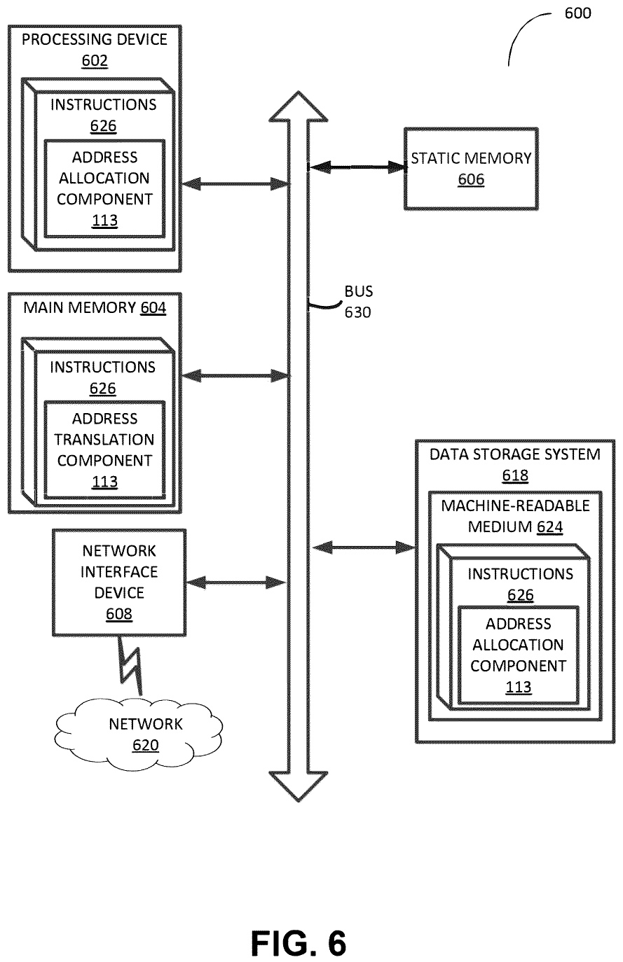

FIG. 6 illustrates an example machine of a computer system 600 within which a set of instructions, for causing the machine to perform any one or more of the methodologies discussed herein, can be executed. In some embodiments, the computer system 600 can correspond to a host system (e.g., the host system 120 of FIGS. 1A-B) that includes, is coupled to, or utilizes a memory sub-system (e.g., the memory sub-system 110 of FIGS. 1A-B) or can be used to perform the operations of a controller (e.g., to execute an operating system to perform operations corresponding to the address translation component 113 of FIGS. 1A-B, or the address assignment component 121 of FIG. 1A and FIG. 1C). In alternative embodiments, the machine can be connected (e.g., networked) to other machines in a LAN, an intranet, an extranet, and/or the Internet. The machine can operate in the capacity of a server or a client machine in client-server network environment, as a peer machine in a peer-to-peer (or distributed) network environment, or as a server or a client machine in a cloud computing infrastructure or environment.

The machine can be a personal computer (PC), a tablet PC, a set-top box (STB), a Personal Digital Assistant (PDA), a cellular telephone, a web appliance, a server, a network router, a switch or bridge, or any machine capable of executing a set of instructions (sequential or otherwise) that specify actions to be taken by that machine. Further, while a single machine is illustrated, the term “machine” shall also be taken to include any collection of machines that individually or jointly execute a set (or multiple sets) of instructions to perform any one or more of the methodologies discussed herein.

The example computer system 600 includes a processing device 602, a main memory 604 (e.g., read-only memory (ROM), flash memory, dynamic random access memory (DRAM) such as synchronous DRAM (SDRAM) or Rambus DRAM (RDRAM), etc.), a static memory 606 (e.g., flash memory, static random access memory (SRAM), etc.), and a data storage system 618, which communicate with each other via a bus 630.

Processing device 602 represents one or more general-purpose processing devices such as a microprocessor, a central processing unit, or the like. More particularly, the processing device can be a complex instruction set computing (CISC) microprocessor, reduced instruction set computing (RISC) microprocessor, very long instruction word (VLIW) microprocessor, or a processor implementing other instruction sets, or processors implementing a combination of instruction sets. Processing device 602 can also be one or more special-purpose processing devices such as an application specific integrated circuit (ASIC), a field programmable gate array (FPGA), a digital signal processor (DSP), network processor, or the like. The processing device 602 is configured to execute instructions 626 for performing the operations and steps discussed herein. The computer system 600 can further include a network interface device 608 to communicate over the network 620.

The data storage system 618 can include a machine-readable storage medium 624 (also known as a computer-readable medium) on which is stored one or more sets of instructions 626 or software embodying any one or more of the methodologies or functions described herein. The instructions 626 can also reside, completely or at least partially, within the main memory 604 and/or within the processing device 602 during execution thereof by the computer system 600, the main memory 604 and the processing device 602 also constituting machine-readable storage media. The machine-readable storage medium 624, data storage system 618, and/or main memory 604 can correspond to the memory sub-system 110 of FIGS. 1A-B.

In one embodiment, the instructions 626 include instructions to implement functionality corresponding to the address translation component 113 of FIGS. 1A-B, or the address assignment component 121 of FIG. 1A and FIG. 1C). While the machine-readable storage medium 624 is illustrated in an example embodiment to be a single medium, the term “machine-readable storage medium” should be taken to include a single medium or multiple media that store the one or more sets of instructions. The term “machine-readable storage medium” shall also be taken to include any medium That is capable of storing or encoding a set of instructions for execution by the machine and that cause the machine to perform any one or more of the methodologies of the present disclosure. The term “machine-readable storage medium” shall accordingly be taken to include, but not be limited to, solid-state memories, optical media, and magnetic media.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. The present disclosure can refer to the action and processes of a computer system, or similar electronic computing device, that manipulates and transforms data represented as physical (electronic) quantities within the computer system's registers and memories into other data similarly represented as physical quantities within the computer system memories or registers or other such information storage systems.

The present disclosure also relates to an apparatus for performing the operations herein. This apparatus can be specially constructed for the intended purposes, or it can include a general purpose computer selectively activated or reconfigured by a computer program stored in the computer. Such a computer program can be stored in a computer readable storage medium, such as, but not limited to, any type of disk including floppy disks, optical disks, CD-ROMs, and magnetic-optical disks, read-only memories (ROMs), random access memories (RAMs), EPROMS, EEPROMs, magnetic or optical cards, or any type of media suitable for storing electronic instructions, each coupled to a computer system bus.

The algorithms and displays presented herein are not inherently related to any particular computer or other apparatus. Various general purpose systems can be used with programs in accordance with the teachings herein, or it can prove convenient to construct a more specialized apparatus to perform the method. The structure for a variety of these systems will appear as set forth in the description below. In addition, the present disclosure is not described with reference to any particular programming language. It will be appreciated that a variety of programming languages can be used to implement the teachings of the disclosure as described herein.

The present disclosure can be provided as a computer program product, or software, that can include a machine-readable medium (e.g., a computer-readable non-transitory storage medium) having stored thereon instructions (e.g., executable instructions), which can be used to program a computer system (or other electronic devices) to perform a process according to the present disclosure. A machine-readable medium includes any mechanism for storing information in a form readable by a machine (e.g., a computer). In some embodiments, a machine-readable (e.g., computer-readable) medium includes a machine (e.g., a computer) readable storage medium such as a read only memory (“ROM”), random access memory (“RAM”), magnetic disk storage media, optical storage media, flash memory components, etc.

In the foregoing specification, embodiments of the disclosure have been described with reference to specific example embodiments thereof. It will be evident that various modifications can be made thereto without departing from the broader spirit and scope of embodiments of the disclosure as set forth in the following claims. The specification and drawings are, accordingly, to be regarded in an illustrative sense rather than a restrictive sense.

What is claimed is:

1. A system comprising:
a memory device comprising a first portion addressable by a first portion of physical addresses of the memory device, and a second portion addressable by a first portion of virtual addresses of a plurality of contiguous virtual addresses, wherein the first portion of virtual addresses contiguously maps to a second portion of physical addresses of the memory device; and
a processing device operatively coupled to the memory device, the processing device to perform operations comprising:
receiving a first request for a first assignment of memory addresses;
determining, based on the first request, whether to assign a first set of physical addresses for the first assignment of memory addresses from the first portion of physical addresses;
responsive to determining not to assign the first set of physical addresses from the first portion of physical addresses, requesting a first set of virtual addresses of the plurality of contiguous virtual addresses; and
storing first data to a second set of physical addresses contiguously mapped to the first set of virtual addresses.

2. The system of claim 1, wherein the second set of physical addresses comprise physical addresses of the second portion of physical addresses of the memory device.

3. The system of claim 2, the operations further comprising:
receiving a request to access the first data stored at physical addresses of the memory device;
determining, based on the request, that the first data is addressable by the first set of virtual addresses; and
processing the request using the second set of physical addresses.

4. The system of claim 3, wherein determining that the first data is addressable by the first set of physical addresses comprises:
determining that a value of set bit of an address of the request indicates the first data is addressable by virtual addresses.

5. The system of claim 3, the operations further comprising:
determining that an address of the request is within an address range indicating the data is addressable by virtual addresses.

6. The system of claim 1, the operations further comprising:
receiving a second request for a second set of memory addresses;
determining, based on the second request, to request a second set of virtual addresses of the plurality of contiguous virtual addresses; and
storing data to a third set of physical addresses contiguously mapped to the second set of virtual addresses.

7. The system of claim 6, wherein the first request and the second request pertain to a first application of the system.

8. The system of claim 6, wherein the first request pertains to a first application of the system, and the second request pertains to a second application of the system.

9. The system of claim 1, the operations further comprising:
responsive to determining to assign the first set of physical addresses, storing the first data to the first set of physical addresses.

10. The system of claim 9, wherein the plurality of contiguous virtual addresses are stored in a global address translation table, wherein the operations further comprise:
sending an indication to update the global address translation table to reflect that the first set of physical addresses are assigned as the first assignment of memory addresses.

11. The system of claim 10, further comprising:
a data structure comprising an address table, wherein entries of the address table indicate a virtual address of the plurality of contiguous virtual addresses and a corresponding physical address that is contiguously mapped to the virtual address, and wherein the data structure further comprises a bit mask vector, wherein each entry of the bit mask vector indicates whether a respective set of virtual addresses of the plurality of contiguous virtual addresses are assigned as an assignment of memory addresses.

12. The system of claim 1, wherein the memory device is a cache coupled to a compute unit, wherein the cache comprises instruction sets for the compute unit.

13. A method comprising:
receiving a first request for a first assignment of memory addresses;
determining, based on the first request, whether to assign a first set of physical addresses for the first assignment of memory addresses from a first portion of physical addresses of a memory device, wherein a second portion of physical addresses of the memory device maps to virtual addresses of a plurality of contiguous virtual addresses;
responsive to determining not to assign the first set of physical addresses from the first portion of physical addresses, requesting a first set of virtual addresses of the plurality of contiguous virtual addresses; and
storing data to a second set of physical addresses contiguously mapped to the first set of virtual addresses.

14. The method of claim 13, wherein the second set of physical addresses comprise physical addresses of the second portion of physical addresses of the memory device.

15. The method of claim 13, further comprising:
receiving a second request for a second set of memory addresses;
determining, based on the second request, to request a second set of virtual addresses of the plurality of contiguous virtual addresses; and
storing data to a third set of physical addresses contiguously mapped to the second set of virtual addresses.

16. The method of claim 13, further comprising:
responsive to determining to assign the first set of physical addresses, storing the data to the first set of physical addresses.

17. The method of claim 16, wherein the plurality of contiguous virtual addresses are stored in a global address translation table, the method further comprising:
sending an indication to update the global address translation table to reflect that the first set of physical addresses are assigned as the first assignment of memory addresses.

18. A computer-readable non-transitory storage medium comprising executable instructions that, when executed by a controller managing a memory device comprising a plurality of memory cells, cause the controller to perform operations comprising:
receiving a first request for a first assignment of memory addresses;
determining, based on the first request, whether to assign a first set of physical addresses for the first assignment of memory addresses from a first portion of physical addresses of a memory device, wherein a second portion of physical addresses of the memory device maps to virtual addresses of a plurality of contiguous virtual addresses;
responsive to determining not to assign the first set of physical addresses from the first portion of physical addresses, requesting a first set of virtual addresses of the plurality of contiguous virtual addresses; and
storing data to a second set of physical addresses contiguously mapped to the first set of virtual addresses.

19. The computer-readable non-transitory storage medium of claim 18, the operations further comprising:
responsive to determining to assign the first set of physical addresses, storing the data to the first set of physical addresses.

20. The computer-readable non-transitory storage medium of claim 19, wherein the plurality of contiguous virtual addresses are stored in a global address translation table, the operations further comprising:
sending an indication to update the global address translation table to reflect that the first set of physical addresses are assigned as the first assignment of memory addresses.
